(19) United States
(12) Patent Application Publication
(10) Pub. No.: US 2021/0342919 A1
(43) Pub. Date: Nov. 4, 2021

(54) SYSTEM AND METHOD FOR CROSS CATALOG SEARCH

(71) Applicant: IVALUA SAS, Massy Cedex (FR)

(72) Inventors: Patrick CONQUET, Massy Cedex (FR); Gilles GAUDICHE, Massy Cedex (FR); David KHUAT-DUY, Massy Cedex (FR)

(21) Appl. No.: 17/376,479

(22) Filed: Jul. 15, 2021

Related U.S. Application Data
(63) Continuation of application No. PCT/US2020/013566, filed on Jan. 14, 2020.
(60) Provisional application No. 62/792,844, filed on Jan. 15, 2019.

(51) Int. Cl. G06Q 30/06; G06F 9/54; G06F 16/9538; G06F 21/31

(52) U.S. Cl. CPC G06Q 30/0633; G06F 21/31; G06F 16/9538; G06F 9/547

(57) ABSTRACT

System and method for receiving a search query for a commodity at a procurement system. The procurement system retrieves an internal listing of items from an internal catalog that pertain to the commodity being searched. Furthermore, the search query is transmitted to APIs of external catalogs organized in iXML format and retrieves an external listing of items pertaining to the commodity. Both the internal and external items are stored in a temporary searchable database that is accessible to a buyer. The external hems and internal items are compared and then select items added to a shopping cart for subsequent purchase requisition and/or purchase order.

### CROSS-REFERENCE TO RELATED APPLICATIONS

This application is a continuation of International Application No. PCT/US2020/013566, filed Jan. 14, 2020, which claims the benefit of U.S. Provisional Application Ser. No. 62/792,844 filed Jan. 15, 2019, under 35 U.S.C. § 119(a). Each of the above-referenced patent applications is incorporated by reference in its entirety.

### BACKGROUND OF THE INVENTION

### Field of the Invention

Procurement systems assist enterprise buyers to search for products, compare prices, and electronically purchase and order products. Such procurement systems typically include an electronic catalog with information from multiple suppliers. The electronic catalog contains information that differs from electronic product catalogs, which are generally made available to the public. For example, the electronic catalog in the procurement system for enterprise buyers may include negotiated terms and conditions along with contracted pricing, that are generally more favorable than retail pricing.

### Description of the Related Technology

Current procurement systems contain a Catalog Interchange Format (CIF) catalog.

The CIF catalog includes information about a supplier's products and services. Such information is loaded into the buyer's procurement system using a digital file exchange format to electronically communicate a product or service catalog from a supplier to a buyer. Additionally, procurement systems may include a PunchOut catalog which presents an extended list of items beyond the list of available products on the CIF catalog. The PunchOut catalog further includes links capable of redirecting the buyer to the supplier website to place orders and thus expand inventory of available products to the buyer.

Finally, today's procurement systems can include a Level 2 PunchOut catalog. The Level 2 PunchOut catalog combines searching and viewing capabilities of the buyer's procurement system with the expanded inventory of the PunchOut catalog. The Level 2 PunchOut catalog allows the buyer to purchase a punch out item from the supplier's PunchOut website and obtain pricing and availability information. When a buyer performs a search, the PunchOut catalog products appear in search results, However, instead of prices being displayed in search results, a user may select the available link displayed next to the product and will be taken to that specific supplier's PunchOut website for price determination and, in some cases, product availability. The Level 2 PunchOut catalog does not allow the buyer to simultaneously access a broad inventory of products from multiple suppliers with up-to-date availability and pricing information directly from the buyer-side procurement system. Additionally, Level 2 PunchOut does not allow buyers to apply their negotiated terms, conditions, and prices to PunchOut items.

As such, there is a need for an e-procurement system and method that addresses the above problems.

### SUMMARY

In one embodiment a system and method for cross catalog searching. The method comprising: receiving a search query at a procurement system, the procurement system having an internal catalog comprising a first plurality of products from a buyer-side procurement system; retrieving respective ones of the first plurality of products from the internal catalog based on the search query and storing in the internal search database; transmitting the search query to APIs of a plurality of external catalogs, wherein the plurality of external catalogs are organized in iXML format; extracting one or more iXML responses from the APIs of the plurality of external catalogs, wherein each of the one or more iXML responses comprise external catalog data related to respective ones of a second plurality of products; storing the external catalog data related to the respective ones of a second plurality of products in the internal search database; and displaying both the respective ones of the first plurality of products and the second plurality of products on a single interface of the procurement system.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several examples in accordance with the disclosure and are, therefore, not to be considered limiting of its scope, the disclosure will be described with additional specificity and detail through use of the accompanying drawings, in which:

FIG. 1 is a schematic illustration of an e-procurement environment 100 according to one illustrated embodiment.

FIG. 2 is a block diagram illustration of a transcodification process, according to one illustrated embodiment.

FIG. 3 is an example process flow for authentication of the buyer and generating external catalog information particularized for the buyer, according one illustrated embodiment.

FIG. 4A is a high-level workflow illustration of a cross-catalog search process, according one illustrated embodiment.

FIG. 4B is a schematic illustration of a data model impact of the cross-catalog search process, according to an illustrated embodiment.

FIGS. 5-8 are schematic illustrations of screenshots of a display interface of the procurement system at various points along the cross-catalog search process, according to illustrated embodiments.

FIGS. 9A-9B are illustrations of an iXML file format and particular fields being leveraged by suppliers and the procurement system, according to one illustrated embodiment.

FIG. 10 is a schematic illustrations of list view design screenshot from the procurement system display interface illustrating attributes from the iXML data file, according to one illustrated embodiment.

FIG. 11 is a schematic illustrations of a detailed view design screenshot from the procurement system display interface illustrating attributes from the iXML data file, according to illustrated embodiments.

### DETAILED DESCRIPTION OF CERTAIN INVENTIVE EMBODIMENTS

In the following detailed description, reference is made to the accompanying drawings, which form a part hereof. In the drawings, similar symbols or same reference numbers typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Various examples of embodiments of the invention will now be described. The following description provides specific details for a thorough understanding and enabling description of these examples. One skilled in the relevant art will understand, however, that embodiments of the invention may be practiced without many of these details. Likewise, one skilled in the relevant art will also understand that embodiments incorporate many other obvious features not described in detail herein. Additionally, some well-known structures or functions may not be shown or described in detail below, so as to avoid unnecessarily obscuring the relevant description.

The terminology used herein is to be interpreted in its broadest reasonable manner, even though it is being used in conjunction with a detailed description of certain specific examples of the invention. Indeed, certain terms may even be emphasized below; any terminology intended to be interpreted in any restricted manner will, however, be overtly and specifically defined as such in this Detailed Description section.

The figures along with the following discussion provide a brief, general description of a suitable environment in which embodiments of the invention can be implemented. Although not required, aspects of various embodiments are described below in the general context of computer-executable instructions, such as routines executed by a general purpose data processing module, e.g., a networked server computer, cloud server, mobile device, tablet, or personal computer. Those skilled in the relevant art will appreciate that embodiments can be practiced with other communications, data processing, or computer system configurations, including; Internet appliances, hand-held devices (including smart phones, tablets, notebooks, wearable computers, all manner of corded, landline, fixed line, cordless, cellular or mobile phones, smart phones, multi-processor systems, microprocessor-based or programmable consumer electronics, set-top boxes, network PCs, mini-computers, mainframe computers, media players and the like. Indeed, the terms “computer,” “server,” and the like are generally used interchangeably herein, and refer to any of the above devices and systems, as well as any data processor.

While embodiments of the invention, such as certain functions, may be described as being performed on a single device, embodiments of the invention can also be practiced in distributed environments where functions or modules are shared among disparate processing devices, which are linked through a communications network, such as, for example, a Local Area Network (LAN), Wide Area Network (WAN), the Internet, Bluetooth, and Zigbee. In a distributed computing environment, program modules may be located in both local and remote memory storage devices.

Embodiments of the invention may be stored or distributed on tangible computer-readable media, including magnetically or optically readable computer discs, cloud servers, hard-wired or preprogrammed chips (e.g., EEPROM semiconductor chips), nanotechnology memory, biological memory, or other data storage media. Alternatively or additionally, computer implemented instructions, data structures, screen displays, and other data under aspects of embodiments of the invention may be distributed over the Internet and via cloud computing networks or on any analog or digital network (packet switched, circuit switched, or other scheme).

The computer readable medium stores computer data, which data may include computer program code that is executable by a computer, in machine readable form. By way of example, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation Volatile and non-volatile, removable and non-removable media implemented in any method or technology for the tangible storage of information such as computer-readable instructions, data structures, program modules or other data. Computer readable storage media includes, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

Embodiments of the invention are described herein with reference to operational illustration of modules having functional blocks to illustrate methods employed by modules to control a plurality of smart devices via a control device where user interfaces associated with the smart devices are transitionally displayed on the control device. It will be understood that each of the modules, blocks, engines, and combinations thereof may be implemented by analog or digital hardware and computer program instructions. The computer program instructions may be provided to a processor of a general purpose computer, special purpose computer, application-specific integrated circuit (ASIC), or other programmable data processing apparatus such that the instructions, which execute via the processor of the computer or other programmable data processing apparatus, implements the functions/acts specified in the functional blocks of the flowcharts and/or the operational modules.

In some embodiments, the methods illustrated by the functional blocks may occur out of the order noted in the operational illustration of the modules. For example, two blocks shown in succession may be executed substantially concurrently. Alternatively, and/or additionally, the blocks may be executed in reverse order.

A module is a software, hardware, or firmware (or combination thereof) system, process or functionality, or component thereof, that performs or facilitates the processes, features, and/or functions described herein. A module may include sub-modules or engines. Software components of a module may be stored on a computer readable medium. Modules may be integral to one or more servers, or be loaded and executed by one or more servers. One or more modules may be grouped into an application:

A CIF Catalog is a digital file format used to electronically communicate a product or service catalog from a supplier to a buyer. The Catalog Interchange Format (CIF) has been leveraged in the e-procurement industry as the standardized electronic file format for supplier catalogs. CIF has grown into a de facto standard and is widely used by hundreds of thousands of companies throughout the world.

C1F is a hierarchical comma separated variable (CSV) double-quoted format comprised of a file header, line data, and file trailer. The hierarchical format allows parent/child relationships, like with size/color apparel product matrixes, to be represented with relatively minor overhead. A benefit of an electronic catalog such as CIF, is that it eliminates the need for buyers to manually enter item information into their procurement system or convert files from one format to another. Through the CIF standard, suppliers can easily publish catalogs and buyers can easily import them. Instead of focusing on mundane catalog management, purchasing departments could allocate more time on spend management.

However, the simplicity of the CIF catalog comes at the price of product configuration. CIF has no direct representation for product specifications, bill of materials, or product configuration rules. CIF can represent simple products or services, but cannot be used solely for items that require configuration. For configurable products, a CIF catalog is used in conjunction with a PunchOut Catalog.

A PunchOut Catalog, or a PunchOut website, is a method for a corporate purchasing agent to buy from a supplier's website from within the buyer's own procurement application or hosted e-procurement system. A PunchOut website is a standard ecommerce website with the special ability to communicate directly with a procurement system through Commerce extensible Markup Language (cXML) and return a pending purchase order back to the buyer so they don't need to enter product information in the procurement system.

With traditional procurement systems, supplier catalog items would be entered in the procurement system when a purchase order was being created or the item would be located in the procurement system master catalog and added to the purchase order. Over time, procurement systems gain the ability to import supplier catalogs directly into the procurement system. The buying organization, often the purchasing department, has the responsibility to enter the catalog information, convert it from one electronic form to another, and maintain costs.

The CIF (described above) standardized electronic file format for supplier catalogs and eliminated the need for buyers to manually enter item information or convert files from one format to another. Through the CIF standard, suppliers could publish catalogs and buyers could import them. Instead of focusing on mundane catalog management, purchasing departments could allocate more time on spend management. In practice, the CIF is appropriate for catalogs that infrequently change. If a supplier sells a widget or performs a service that stays the same for a long period of time, a CIF file may be used to communicate catalogs under 1,000 items. In this global economy with nimble suppliers, mass customization, and commodity pricing, a catalog of static information, fixed pricing, and the inability to customize is a problem.

The solution to a static product catalog, and in many cases its replacement, has been the e-commerce website. For a corporate purchasing agent working within a procurement system or hosted e-procurement website, accessing an external supplier website may not be possible. Even if it were possible, there is no standard way to automatically enter the item information from the website into the procurement system,

In many cases a static catalog and the inability to exchange information with an e-commerce website reintroduces significant work for the purchasing department. To address this problem, an electronic document interchange standard called the Commerce extensible Markup Language (cXML) and PunchOut concept was introduced by the cxml.org industry consortium.

Through cXML and the PunchOut mechanism, buyers may access a supplier's PunchOut-enabled ecommerce website, be automatically logged in, search the catalog, configure items, add them to the shopping cart, and return the cart as a pending purchase order back to the procurement system. In short a PunchOut website is a standard ecommerce website with the ability to communicate directly with a procurement system through cXML and return a pending purchase order back to the buyer so they don't need to enter product information in the procurement system.

A Level 2 PunchOut combines a PunchOut Web site with a CIF Catalog to create a single shopping environment for PunchOut catalogs and catalogs stored in the procurement system. With a Level 2 PunchOut, users have the ability to search for and view products which would normally only be viewable on the supplier's PunchOut website. A Level 2 PunchOut catalog is a PunchOut-enabled website with the ability to allow the buyer to punch-out directly to an item from within a procurement system.

To better understand a Level 2 PimchOut, it's helpful to reiterate the role of the PunchOut Catalog and the CIF Catalog. From the perspective of the buyer, a supplier is represented as either a list of items in the master catalog of the procurement system or as a link to a PunchOut website—not both at the same time. The buyer can either search among all the suppliers in the master catalog or punch-out to a supplier's PunchOut website and search only that supplier's PunchOut catalog. Ideally the buyer wants to do both: search the master catalog, even items located in the PunchOut catalog, and punch-out to get real-time pricing and availability.

A Level 2 PunchOut marries both worlds. The Level 2 PunchOut-enabled supplier generates a CIF designating the web address (URL) where the item is located, and communicates the CIF to the buyer. In the procurement system the master catalog is updated with the contents of the CIF. The master catalog knows which items are purchased through a standard purchase order and which are purchased through the PunchOut website, allowing for the best of both worlds at the same time.

Through a Level 2 PunchOut, suppliers can provide a CIF catalog of their available products without prices, which are searchable within the procurement system search tool. When a buyer performs a search, the PunchOut catalog products appear in search results, just like the supplier catalogs in the master catalog. Instead of prices being displayed in search results, a user may select the available link displayed next to the product and will be taken to the supplier's PunchOut website for real-time price and, in some cases, product availability and on-hand inventory quantity.

Once at the PunchOut website, users will be directed to the group, category, or item level for the particular item they chose, depending on the configuration of the PunchOut website. From that point forward, products are located, researched, and ordered just like a common PunchOut website.

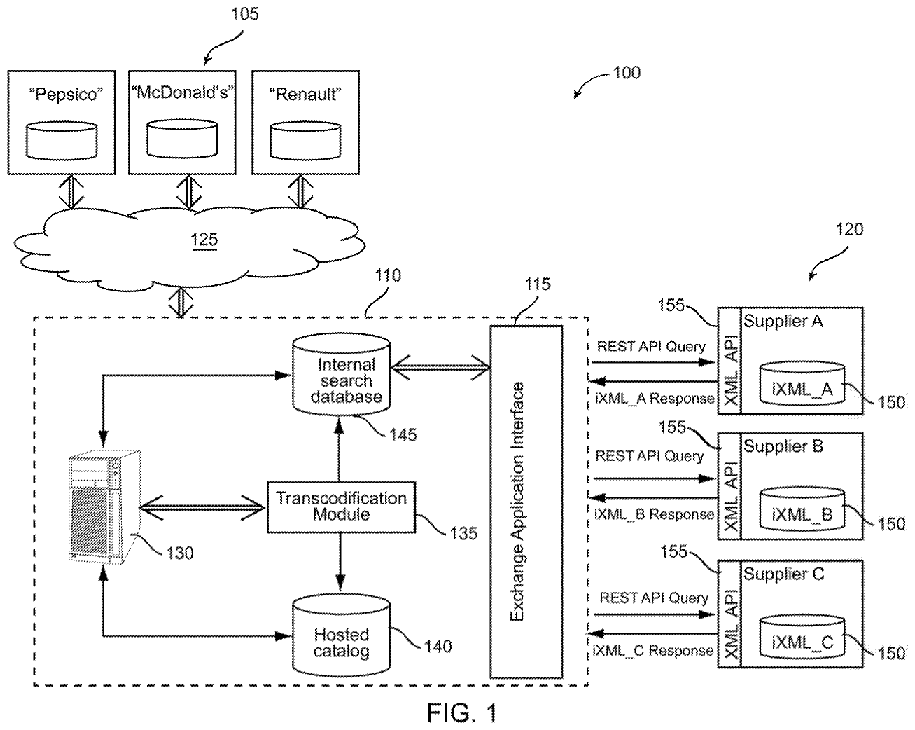

FIG. 1 shows a schematic illustration of an e-procurement environment 100 according to one illustrated embodiment. The environment 100 comprises a plurality of buyers 105 (e.g., PEPSICO, MCDONALDS, RENAULT), a procurement system 110, and a plurality of suppliers 120 (e.g., supplier A, supplier B, suppliers C).

The plurality of buyers 105 may take the form of various business enterprises or individuals engaged in the procurement of supplies, such as products or services. For example, one of the plurality of buyers 105 may be a food-related business that requires frequent procurement of products such as paper goods or computers. The plurality of buyer 105 may be communicatively coupled to the procurement system 110 (e.g., IVALUA, INC. procurement system) via network 125. The network 125 may, for example, comprise a Local Area Network (LAN), Wide Area Network (WAN), the Internet, Infrared, Bluetooth or Zigbee communication protocols, to name a few.

The procurement system 100 may comprise a catalog search engine 130, transcodification module 135, hosted catalog 140, internal search database 145, and an Exchange Application Interface (EAI) 115. The catalog search engine 130 may, for example, take the form of a processor or server operable to receive search queries from a user and implement a product search on the hosted catalog 140 (“internal catalog”) and the internal search database 145. Additionally, the catalog search engine 130 may receive user authentication data such as user-specific login credentials that allows the procurement system 100 to extract product search results from the plurality of external catalogs 150 that is unique to the user. For example, a first user may have negotiated contract terms with various ones of the suppliers 120 that are different from a second user. As such, the product listings stored in the internal search data base 145 is ephemeral and unique to the user initiating the product search within the procurement system 100. As will be described herein, the internal search database 145 may comprise product search results from searching the external catalogs 150 of the plurality of suppliers 120. The internal search database 145 also includes associated external catalog information pertaining to the products being offered by the suppliers 120. The internal search database 145 may be a temporary storage for the product search results from the plurality of suppliers 120 and the product information extracted from their external catalogs 150.

The hosted catalog (or internal catalog) 140 may comprise a listing of items, such as products or services. The listing of items in the hosted catalog 140 may have associated codes specific to the buyer 105. For example, the buyer 105 may have copied some of the supplier 120 external catalogs into its own internal system so that can use buyer-specific codes. Having buyer-specific codes associated with the listed items in the hosted catalog allows the buyer 105 to place a purchase order through its internal purchase process. However, the buyer 105 may not have downloaded and stored the product listings (and associated external catalog 150 information) of the most recent product offerings from all the relevant suppliers 120. The hosted catalog 140 may, for example, comprise the buyer's copy of a few of the supplier's 120 external catalogs 150 at a point in time (which may not be real-time updated). For buyers 105, consistent download and extraction of product listings from scores of potential suppliers 120 and their associated external catalogs 150 is costly, time consuming, and technically challenging. As such the buyers 105 may access the procurement system 110, which will allow the buyers 105 to access both the item listings from the hosted catalog 140 and the items stored in the internal search database 145 upon implementation of the product search process (to be described herein). Having access, from a single interface of the procurement system 110, to both the hosted catalog 140 and the internal search database 145 (i.e., external catalog 150 information of the plurality of suppliers 120) allows the buyers 145 to seamlessly access the most recent product offerings from the external catalogs 150 of the suppliers 120. Additionally, the purchase orders are maintained through the buyer-specific purchase ordering and purchase requisition system and process.

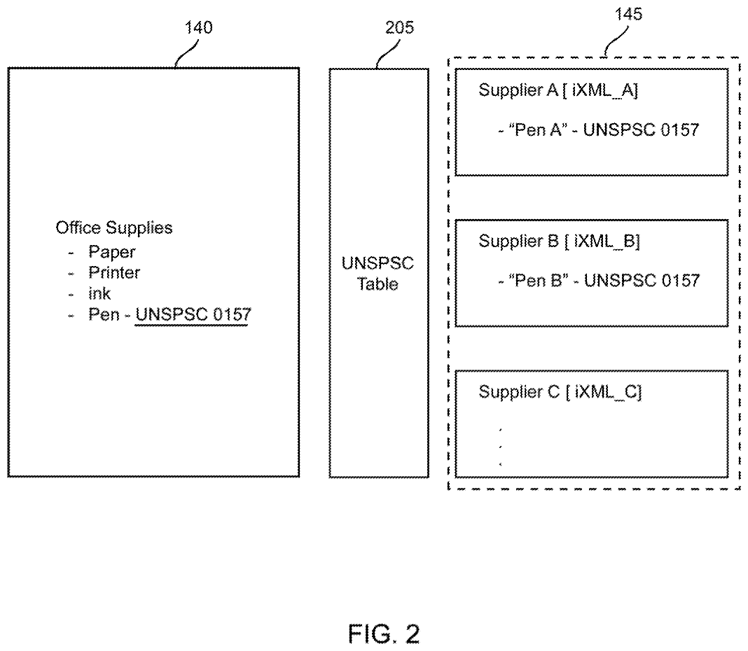

In other words, the procurement system 110 may enable the buyers 105 to have the benefit of the buyer's 105 own internal procurement process (e.g., PO/PR process and system), including buyer-specific category codes for buy-side commodities, and can open that up to include products from the external catalogs 150 (suppliers 120) via the procurement system 110. As will be described herein, the procurement system 110 may leverage a particular XML formatting of external catalog 150 data, which will be referred to herein as iXML format. Additionally, the procurement system 110 may leverage a transcodification process (FIG. 2) to unify the buyer-specific commodity or product codes with the supplier-side codes employed by the suppliers 120 in the external catalogs 150. Thus, the procurement system 110 enables real-time categorization of the products or commodities and real-time access to the external catalogs 150 of the suppliers 120.

The transcodification module 135 is configured to implement transcodification between the items listed in the hosted catalog 140 and the items stored in the internal search database 145. FIG. 2 is a block diagram illustration of the transcodification implemented by the transcodification module 135. The transcodification module 135 may be communicatively coupled to both the hosted catalog 140 and the internal search database 145. Additionally, the transcodification module 135 may have access to a UNSPSC table 205. According to one embodiment, responsive to the procurement system 110 receiving the product search query from the user, the transcodification module 135 may operate to associate the particular product/service being searched with the relevant UNSPSC code. The example illustrated in FIG. 2 shows a “Pen” as the product being queried by the user. As will be described below, the procurement system 110 may access the external catalogs 150 of the suppliers 120 and extract the “Pen” products being offered by the Suppliers A and B (i.e., suppliers 120) along with the associated UNSPSC code (e.g., UNSPSC 0157). The transcodification module 135 may convert or associate the buyer-side code for the “Pen” with the same UNSPSC code (e.g., UNSPSC 0157) used in the external catalogs 150 of the Suppliers A and B. As a result, the catalog search engine 130 may seamlessly index or search both the internal search database 145 and the hosted catalog 140, including allowing for comparison of products listed on the host catalog 140 with the same products listed on the internal search database 145.

The plurality of suppliers 120 may comprise corporations or any supplier-related business that may fulfill procurement requests for products or services from the buyers 105. Some example suppliers 120, for purpose of illustration, may be OFFICE DEPOT, STAPLES, DELL, INTEL, QUALCOMM, HONEYWELL, GOODYEAR, DUPONT, GENERAL ELECTRIC, BOSCH, to name a few. It will be appreciated that the list of suppliers is not exhaustive and not intended to limit to any single industry but includes all industries now known or later developed.

Each of the plurality of suppliers 120 may comprise the external catalog 150, which includes a listing of products/services being offered for sale to the buyers 105. Embodiments of this disclosure contemplate the suppliers 120 having their respective APIs open to the procurement system 110. In particular, the suppliers 120 provide an XML interface 155 with consistent format across all the suppliers 120 such that the procurement system 110 may directly access the underlying external catalogs 150. XML is a data exchange format allowing access and exchange of data. In other words, instead of having the procurement system 110 interrogate the plurality of external catalogs 150 through a web site or web interface, the procurement system 110 may directly access the external catalogs 150 of the suppliers 120 via the respective APIs 155 of the external catalogs 150 of the suppliers 120, The external catalogs 150 may be created by the suppliers 120 in iXML format (iXML_A, iXML_B, iXML_C) where external catalog information associated with the products/services in the external catalogs 150 are stored according to defined data fields. Having the suppliers 120 expose their respective APIs to the procurement system 100 allows for the plurality of buyers 105 to have access to up-to-date external catalog information by accessing the procurement system 100 (e.g., IVALUA, Inc.'s procurement platform).

The Exchange Application Interface (EAI) 115 is configured to query the APIs 155 of the plurality of suppliers 120 and directly access the underlying external catalogs 150 of each of the suppliers 120. In one embodiment, the EAI 115 and the external catalogs 150 of the suppliers 120 interoperate using a REST (Representational State Transfer) architectural style to allow for the procurement system 100 to access the iXML data fields of the external catalogs 150. In particular, the EAI 115 may launch several asynchronous queries (e.g., REST API query) to respective ones of the APIs 155 associated with the plurality of suppliers 120. The EAI 115 may extract one or more iXML responses (iXML A response, iXML_B response, iXML_C response) from the plurality of API interfaces 155 associated with the suppliers 120. The iXML responses may include the external catalog information in iXML format, which may be ultimately stored in the internal search database 145 of the procurement system 110.

In particular, each of the APIs may receive a keyword and the user authentication information identifying the particular buyer 105 accessing the procurement system 110 to search the supplier's 120 external catalog 150 (iXML_A). The user authentication information may be leveraged by the APIs 155 to search in the respective supplier's 120 external catalog 150 after applying negotiated contract terms specific to the particular buyer 105. The API 150 may return the search result from the external catalog 150 via the iXML response which includes a list of items (products/services) with the name, descriptions, reference, characteristics, price, etc. as a standardized XML file in the iXML format (described in more detail herein). As such, the data retrieved after a REST API query is unique to each user. Each iXML response from the APIs 155 may be processed by the procurement system 110 in real-time such that the internal search database 145 is up-to-date when the catalog search engine 130 operates the search process on the internal search database 145 and the hosted catalog 140. Because the data stored in the internal search database 145 is particular for each user, the data stored in the internal search database 145 is removed for a subsequent search by another user.

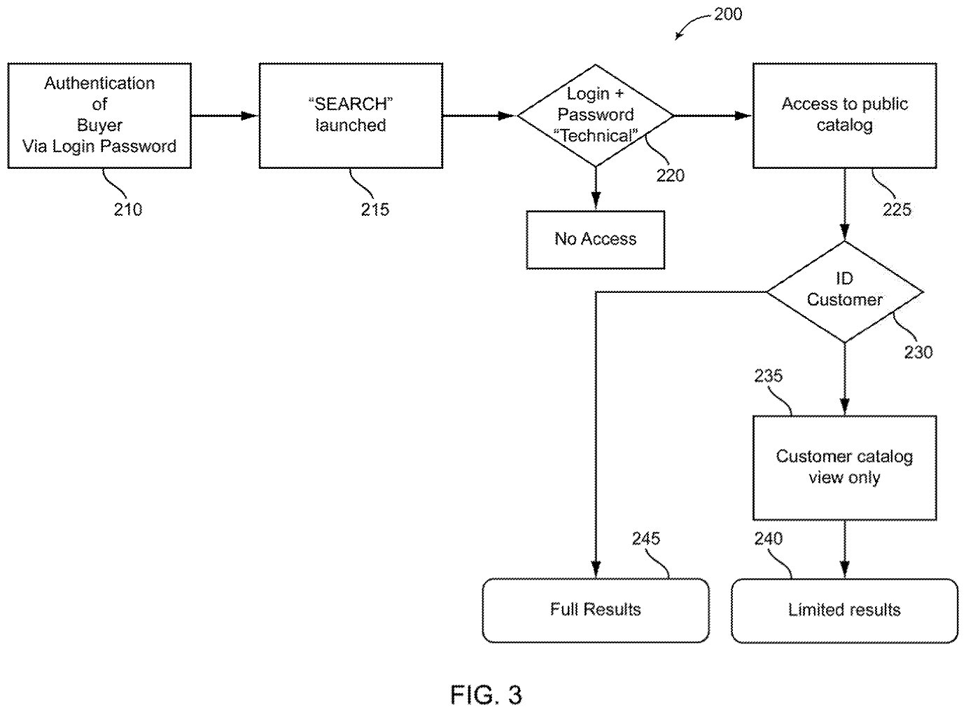

FIG. 3 shows an example process flow 200 for authentication of the buyer 105 and generating external catalog information particularized for the buyer, according one illustrated embodiment.

The process flow 200 starts at 210. At 210, the user (i.e., the buyer 105) enters login credentials (e.g., username and password) to gain access into the procurement system 110. At 215, once the buyer 105 is authenticated, the buyer 105 may initiate a search for products/services via the procurement system 110.

As mentioned above, the EAI 115 may query the APIs 155 of the plurality of suppliers 120 and directly access the underlying external catalogs 150 of each of the suppliers 120. However, at step 220, the procurement system 110 runs a “technical” or behind-the-scenes credential evaluation pertaining to the buyer 105. In one embodiment, the procurement system 100 refrains from pinging the buyer 105 to re-enter his/her login credentials again as the original login creates a token recognized by the procurement system 100 for evaluating access permissions later in the search process with the plurality of suppliers 120. Instead, the login credentials entered by the buyer 105 at step 210 serves as a single sign-in to eligible external catalogs 150 of the suppliers 120. If the buyer 105 credentials are not recognized at step 220, no access is provided to search the external catalogs 150.

At 225, the procurement system 100 permits the EAI to query the APIs of various supplier catalogs 150 that are accessible to the general buyer community or the public. However, at step 230, the process identifies the particular buyer 105. If the buyer 105 credentials allow for access to particular negotiated items (products/services), then the process 200 proceeds to steps 235, 240. At 235, 240, the EAI may retrieve external catalog information from the external catalog 150 that is particularized to the buyer 105. For example, the buyer 105 may have negotiated specific prices or bundles of products with the suppliers) 105. Otherwise, at 245, the buyer 105 is granted the general access to the external catalog 150 of the supplier 120 without negotiated contract terms for the products/services.

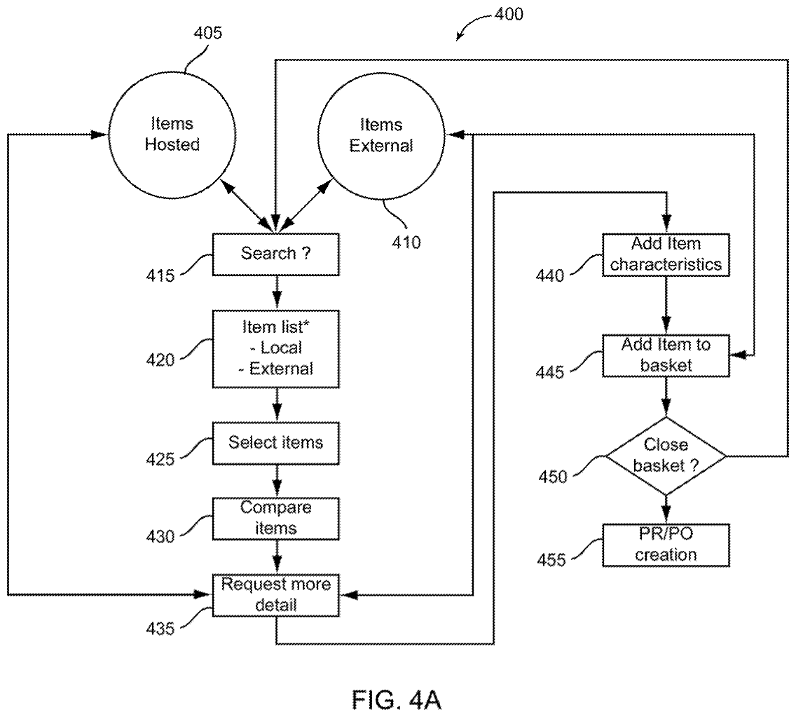

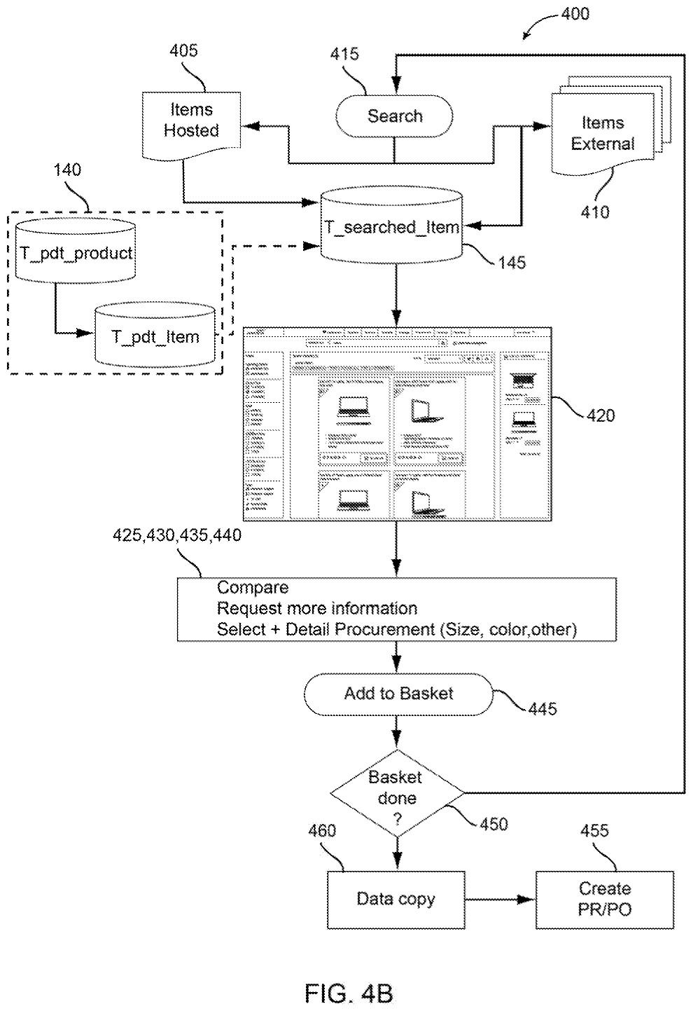

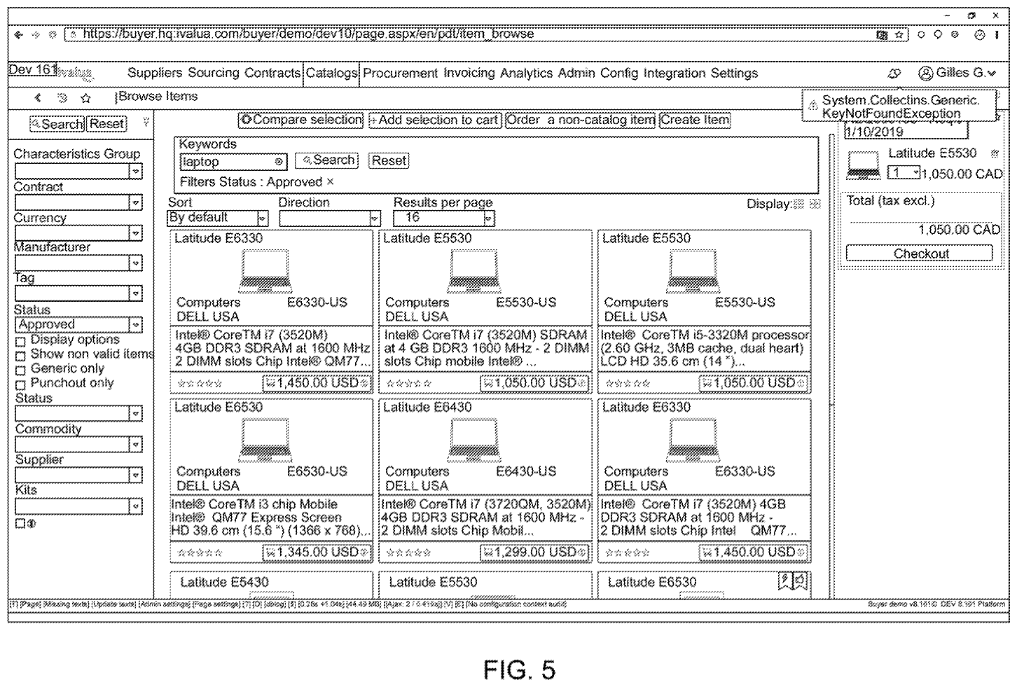

FIG. 4A shows a high-level workflow illustration of a cross-catalog search process 400, while FIG. 4B shows a schematic illustration of a data model impact of the cross-catalog search process 400, according to an illustrated embodiment Additionally, FIGS. 5-8 are schematic illustrations of screenshots of the display interface of the procurement system 110, according to illustrated embodiments. Reference will be made to FIGS. 5-8 within the description of FIGS. 4A-4B.

The process 400 may be initiated responsive to a search query 415. The search query 415 may, for example, be a keyword search or a selection of a category of keywords (e.g., commodity, supplier). As an example, the buyer 105 may enter “paper” as a search query or a more narrowed search of perhaps “paper bundles.” In another embodiment, the buyer 105 may initiate a more directed search for “paper bundles over 100 sheets.” It will be appreciated by those of ordinary skill in the art that the disclosure contemplates all forms and content of search queries. In the FIG. 5 example, the buyer 105 enters the keyword “laptop” as a search query into the procurement system 110. In particular, the keyword may be received by the catalog search engine 130.

As mentioned above, the EAI 115 transmits queries to the respective APIs 155 of the suppliers 120 to search the associated external catalogs 150 based on the keyword (e.g., laptop). The APIs 155 of the suppliers 120 respond with external catalog data in the iXML format. The procurement system 110 extracts the external catalog data from the various fields in the iXML file and stores in the internal search database 145 as a list of external items 410. Additionally, the catalog search engine 130 runs the keyword search on the hosted catalog 140 to generate a list of hosted items 405. At 420, the procurement system 110 may combine both the list of hosted items 405 and the list of external items 410 and store in the internal search database 145 or any other temporary database. Having the internal and external items stored in the internal search database 145 allows for the data to be manipulated by filtering and additional search requests in a seamless and efficient manner.

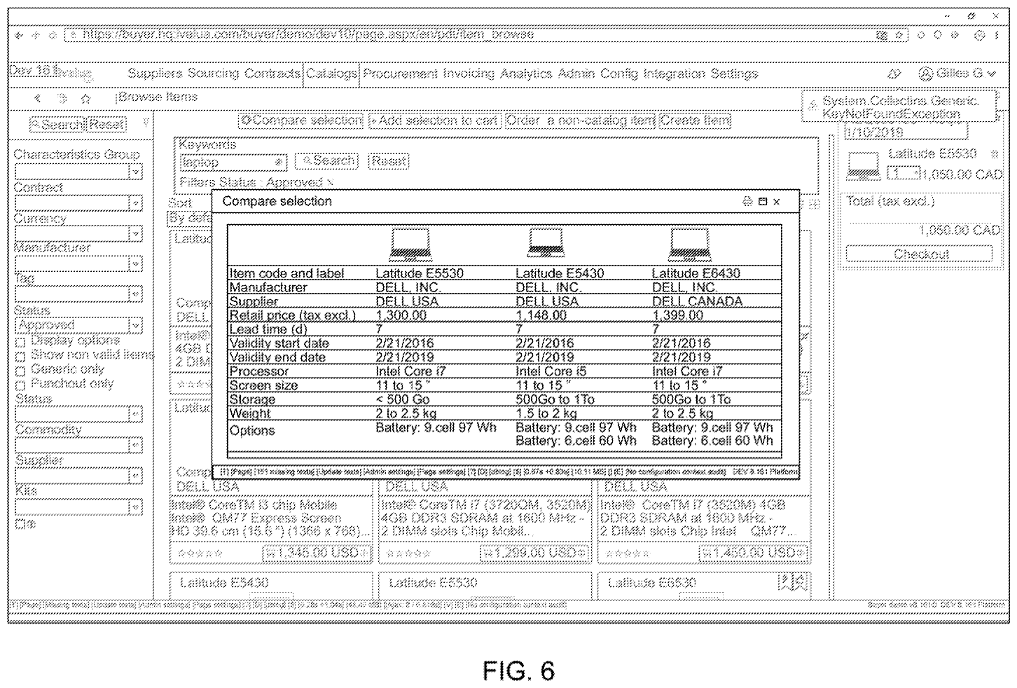

The list of external items 410 may comprise a partial answer from the external catalogs 150. The list of external items 410 may include a GroupID and list of possible characteristics of the product. For example, FIG. 5 illustrates a list of laptop computers that includes supplier, manufacturer, item code and label, and short description. In other words, the partial answer from the external catalogs 150 provides the buyer 105 with sufficient information to decide on whether to pursue a more refined search. At 425-430, the buyer 105 may even select several items from the combined display of internal and external items to easily compare the items (FIG. 6). In some embodiments, the buyer 105 may initiate various filters to further analyze the displayed listing of internal and external items (e.g., products/services). For example, the buyer 105 may filter based on “Characteristics Group,” “Contract, “Currency,” “Manufacturer,” “PunchOut Only,” or “Supplier” to name a few.

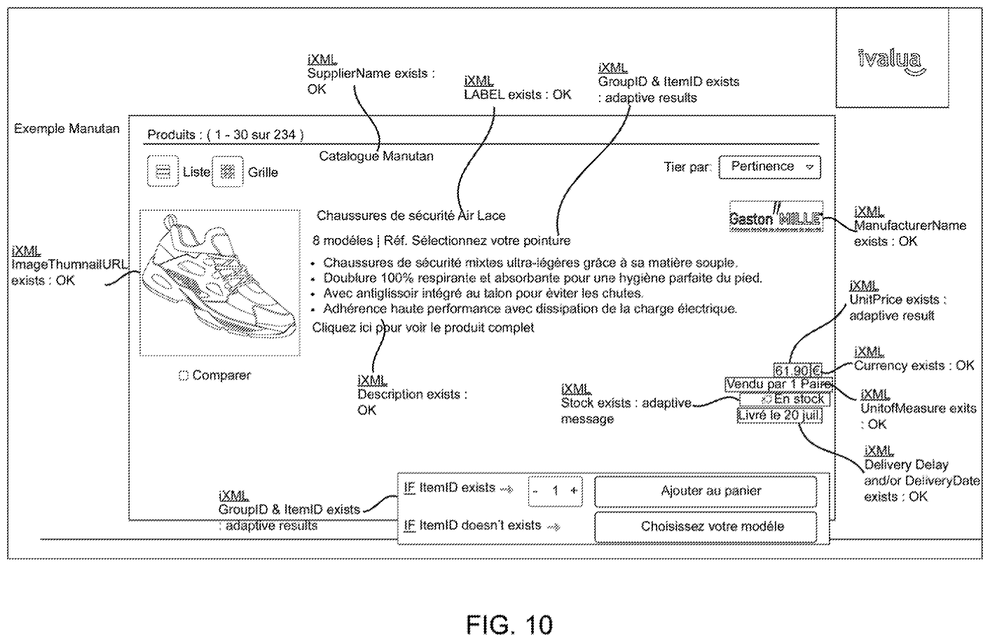

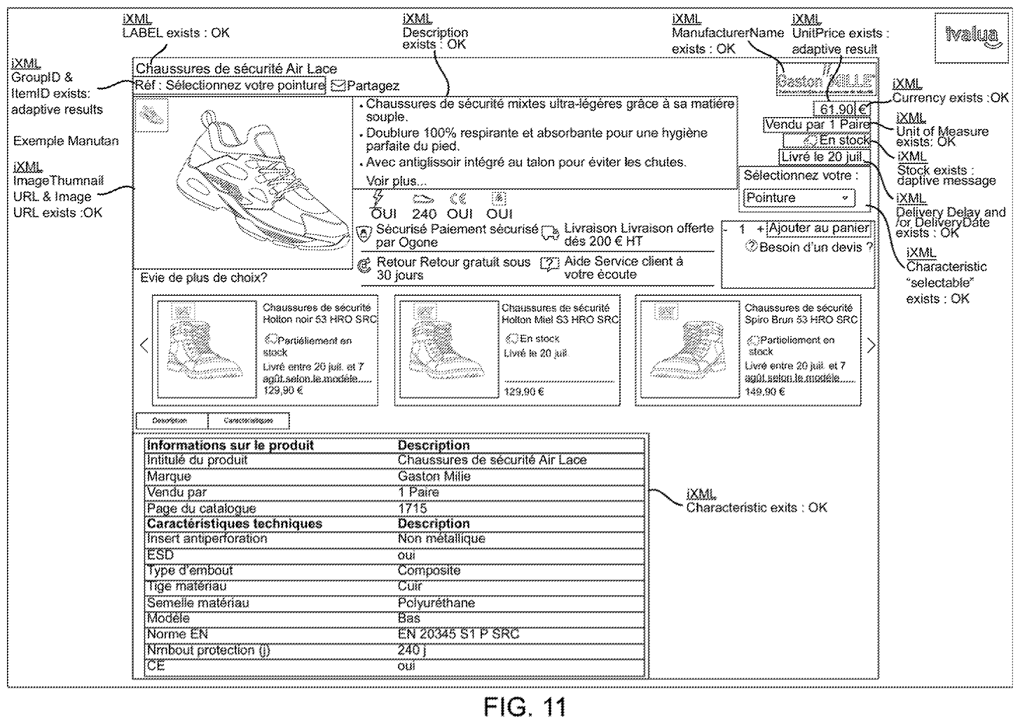

Regardless of whether additional filters are employed, the buyer 105 may select respective ones of the listed items in the internal search database 145 to request more detail at 435. Requesting more detail of selected external items 410 from the internal search database 145 may initiate another exchange of data with the relevant suppliers 120. This subsequent data exchange may also occur using the iXML format. In one embodiment, for the selected external items 410, the EAI 115 may initiate a subsequent query of the respective APIs 155 of the suppliers 120. The subsequent API query of respective external catalogs 150 may be directed to a particular GroupID and buyer-selected characteristics of the product. The supplier 105 may select a specific Item1D, via the API 155, and respond with an iXML response including a full description of the product (e.g., detailed Item1D). FIGS. 10-11 are example screenshot illustrations of a detailed product description from the supplier 120. In the FIG. 10-11 screenshot illustrations, the suppliers 120 provide the subsequent iXML response with the detailed description of a selected item. The more detailed description is stored in the internal search database 145.

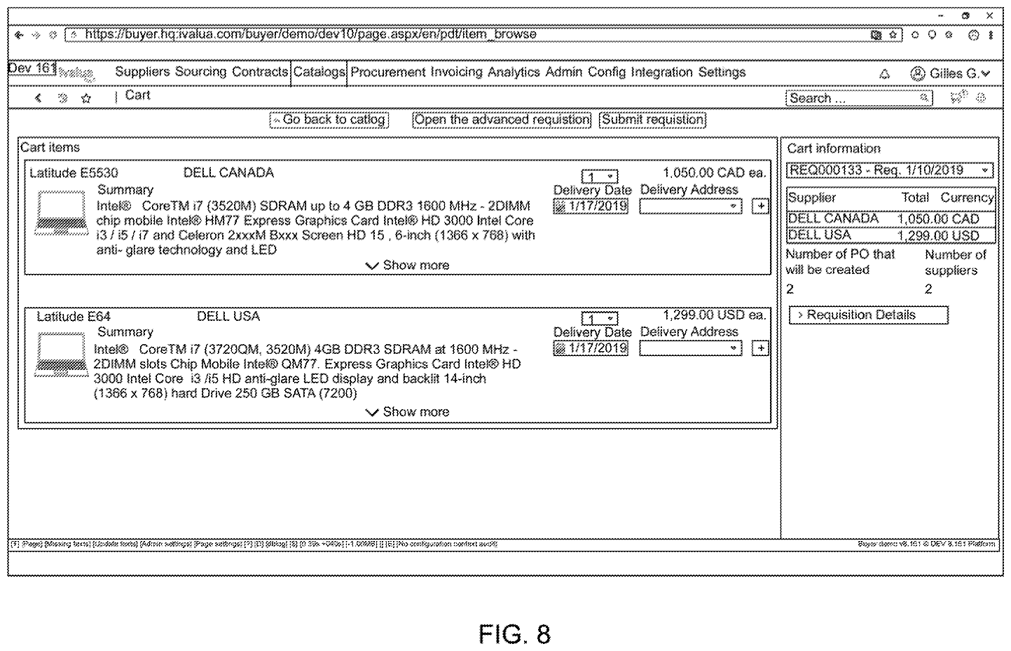

At 440, the buyer 105 may determine the item characteristics to select before creating a purchase order (PO) or purchase requisition (PR) for the selected item (e.g., product/service). For example, the item characteristics may be a size, color, currency type, quantity, delivery date, etc. At 445, the selected items with the associated characteristics may be added to a basket or shopping cart (FIG. 8).

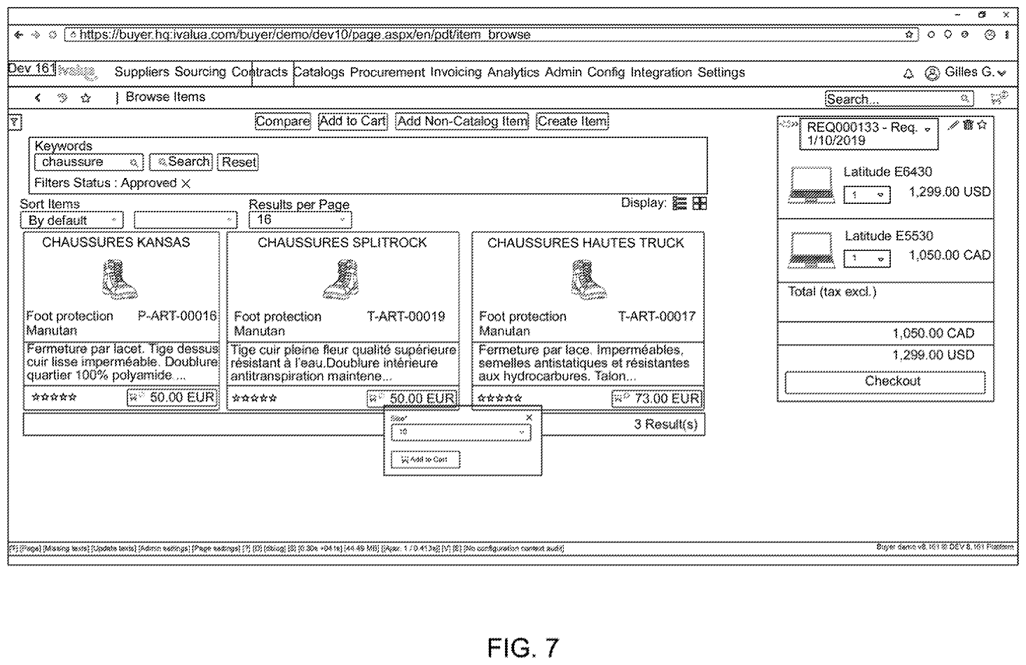

At 450, the buyer 105 may run an additional search query for other items to evaluate for potential requisition and purchase. The above described cross-catalog process may be repeated for a new keyword. FIG. 7 shows a screenshot illustration of the buyer 105 running a keyword search for “chaussure” (which means “shoe” in English). Similarly to the “laptop”—search previously described, the procurement system 110 implements a search of the external catalogs ISO via the open APIs 155 of the suppliers 120. As mentioned above and described in more detail below, the iXML data format may be leveraged. The search may be a two-tiered process, where the initial search results are a partial answer from the supplier 120 (e.g., GroupID and possible characteristic list). Upon the buyer 105 selecting and/or completing the characteristics associated with the desired items, a subsequent search request (GroupID and selected characteristics) results in a detailed description (e.g., detailed ItemID) being received from the suppliers 120. As such, the combined listing of internal and external items displayed by the procurement system 110 is asynchronously updated based on the subsequent iXML responses from suppliers 120 APIs 155.

At 460, the buyer may select the additional items to be copied to the basket or shopping cart upon selecting the item characteristics (FIG. 7). In the FIG. 7 example screenshot illustration, the buyer 105 selects the shoe size prior to adding to the shopping cart. At 455, upon validation by the buyer 105, the procurement system 110 creates the PR and PO. Allowing the procurement system 110 to execute the PR and PO process assures the proper account reviewing process takes place that is in line with the buyer's 105 processes.

It will be understood that the cross-catalog process described above with regard to FIGS. 4A-4B includes the authentication method described in FIG. 3. In other words, the iXML responses from the APIs 155 of the suppliers 120 will include item details, attributes, and/or characteristics that are particular or unique to the buyer 105 initiating the cross-catalog search. Leveraging the authentication process of FIG. 3 allows for any negotiated contract terms between the buyer 105 implementing the keyword search (search query) and the suppliers 120 to be reflected in the external catalog information being transmitted to the procurement system 110. In one example, the procurement system 110 transmits the buyer 105 authentication credentials to all the suppliers 105 such that the user is already authenticated prior to transmitting the queries to the supplier APIs 155.

Additionally, the cross-catalog process 400 described above may be implemented using a SQL or non-SQL database. Alternatively and/or additionally, the cross-catalog process 400 may include segmenting in the data tables the read/write accesses. In one embodiment, partitions may be employed to address the management of concurrent database accesses when there are multiple searches at the same time. One example partition solution may include:
partition using an integer value;
compute the integer value based on the session ID at the insertion time:
Checksum(Session_ID) % 10000, where“%” is the modulo operator;
Create, for example, 10000 partitions in advance;
the database table is in lock escalation auto instead of default mode;
a single column index on Session_ID (where the index is properly partitioned).

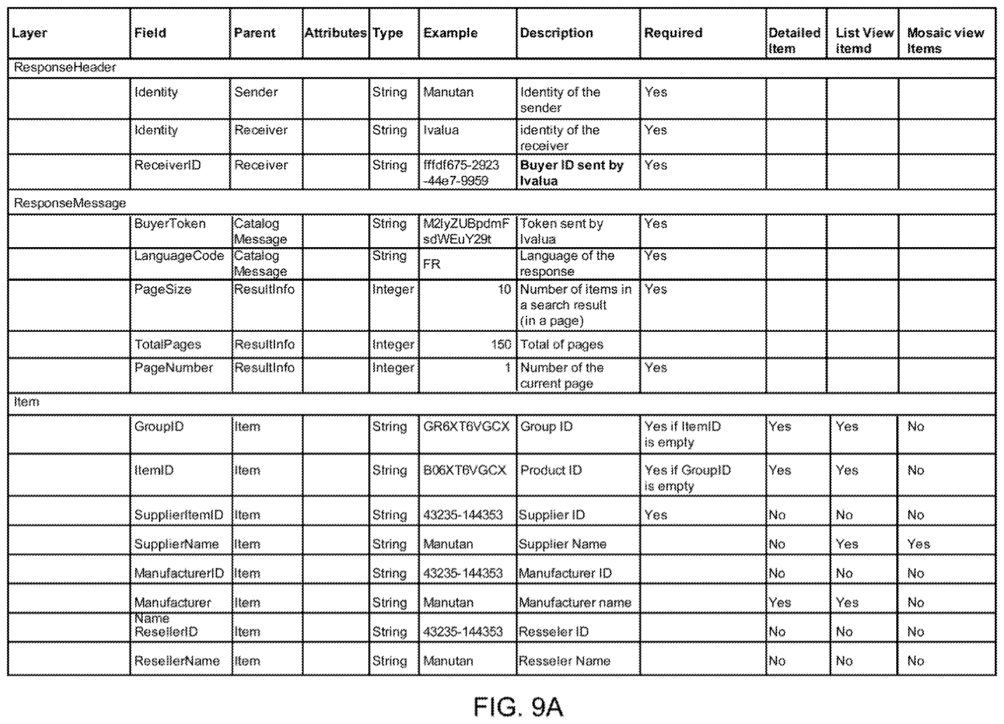

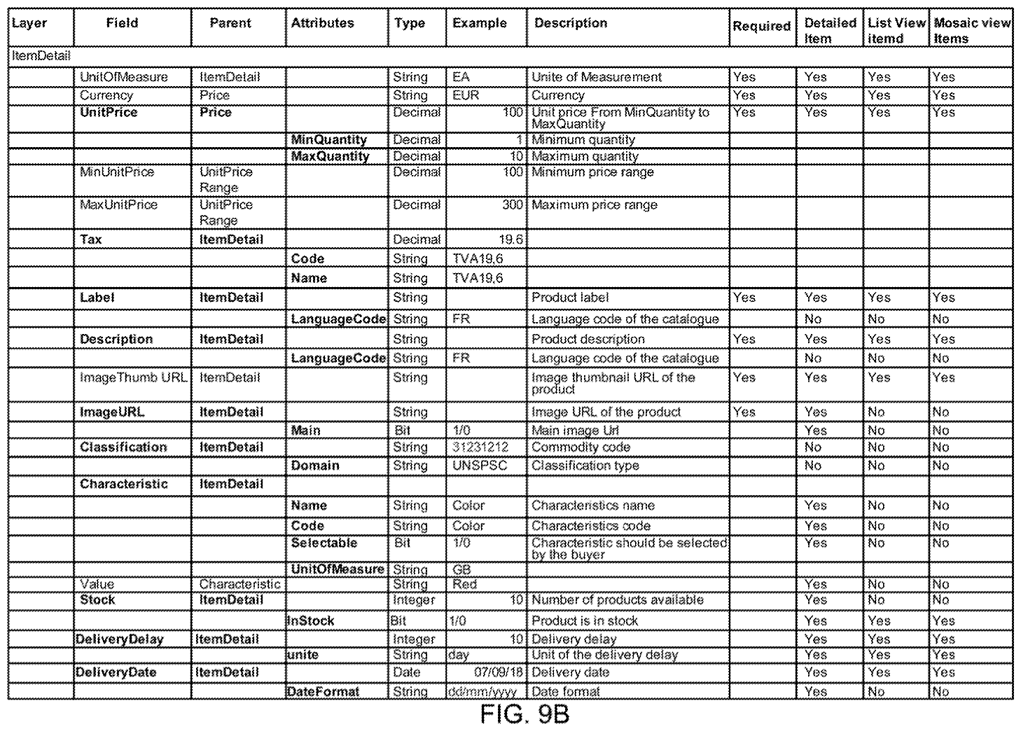

FIGS. 9A-9B are illustrations of the iXML file format and the particular fields being leveraged by the suppliers 120 and the procurement system 110, according to one illustrated embodiment. FIG: 10 is a schematic illustrations of a list view design screenshot from the procurement system 110 display interface, while FIG. 11 is a detailed view design screenshot, according to illustrated embodiments.

It will be appreciated that the iXML file depicted in FIGS. 9A-9B may comprise a single file but has been divided into two portions for purposes of illustration. The iXML file rendering of FIGS. 9A-9B comprises one or more of a Layer, Field, Parent, Attributes, Type, Example, Description, Required, Detailed Item, List View Item, Mosaic View Item categories.

XML data exchange format is a list of data with two columns comprising Field and Type. However, the iXML format contemplated by this disclosure may entail combining the XML format with a logical layer on top of the XML file format where the logical layer specifies attributes to identify data to be associated with various fields of the XML data. The logical layer may refer to attributes associated with the data field and data type. For example, “InStock” is a specific attribute associated with Stock Field and the specific attribute for Type may be a “Bit” (i.e., 1 or 0 depending whether product in stock). As another example, the Description field may have a “LanguageCode” as an attribute, while the Type field has a “String” as an attribute (i.e., FR may be the language code).

FIGS. 10-11 show the linking between the front end user interface of the procurement system 110 and the backend iXML fields with attributes in particular, the FIGS. 10-11 screenshots illustrate the various attributes from the iXML data file.

It will be appreciated that the described embodiments of the disclosure allow search and comparison of products across the hosted catalog 140 and the external catalogs 150 of suppliers 120. In particular, one aspect of the disclosure allows the buyer 105 to combine goods and services from multiple sources and of multiple type product or services with a “cross-punch” capability. This capability improves the product/service search by providing a single search interface that searches the hosted catalog 140 and/or the external catalogs 150 via the APIs 155.

For example, during a cross-catalog search for products, there may be two steps: (1) leverage keywords to retrieve all products/services that meet the search criteria; and (2) collect or retrieve additional product information to display along with the product. One example advantage of direct data access to external catalogs 150 pertains to price updates. In the event of a price update by a particular supplier 120, the price information associated with that product may be updated directly by the supplier 120.

The terms “products” or “items” or “services” or “articles” may be used interchangeably throughout the disclosure. These terms, and similar terms, may be used to refer to a specific commodity. For example, “office supplies” may be a commodity, while “paper” and “printer” may be particular products; within that commodity.

“Transcodification” refers to the process of conforming buy-side commodity codes to the international classification of commodities (i.e., UNSPSC). The United Nations Standard Products and Services Code (UNSPSC) is a taxonomy of products and services for use in eCommerce. For example, it may be a four-level hierarchy coded as an eight-digit number, with an optional fifth level adding two more digits. However, embodiments of the disclosure encompass other classification of commodities as well, such as EU' s Common Procurement Vocabulary, Germany's Eclass, and GS1's Global Product Classification, to name a few.

The term “commodity” refers to category or segment of products/services. For example, a commodity may be “office supplies.” There may be a hierarchy within the “office supplies” commodity of Office Supplies/Printing/Ink.

“iXML” refers to IVALUA, INC.' s specific integration of attributes into fields of the extensible markup language to describe product or services information in the e-procurement industry. An example of the iXML fields formatting is illustrated in FIGS. 9A-9B, while an illustration of front-end integration of the iXML attributes is illustrated in FIGS. 10-11. IVALUA, INC. establishes the iXML field format as a consistent way to describe products/services when interacting with various supplier catalogs (external databases) in an e-procurement system.

Representational State Transfer (REST) is a software architectural style that defines a set of constraints to be used for creating web services. Web services that conform to the REST architectural style, termed RESTful web services, provide interoperability between computer systems on the Internet RESTful web services allow the requesting systems to access and manipulate textual representations of web resources by using a uniform and predefined set of stateless operations. Other kinds of web services, such as SOAP web services, expose their own arbitrary sets of operations.

“Web resources” may include, for example, documents or files identified by their URLs but may encompass any data that can be identified, named, addressed, or handled, in any way whatsoever, on the web. For example, requests made to a supplier's external database elicits a response with payload formatted in iXML format, as described herein.

In a RESTful web service, requests made to a resource's URI may elicit a response with a payload formatted in HTML, XML, JSON, or some other format. The response can confirm that some alteration has been made to the stored resource, and the response can provide hypertext links to other related resources or collections of resources. When HTTP is used, as is most common, the operations available are GET, POST, PUT, DELETE, and other predefined CRUD HTTP methods. By using a stateless protocol and standard operations, RESTful systems provide fast performance, reliability, and the ability to grow, by re-using components that can be managed and updated without affecting the system as a whole, even while it is running.

Example 1 may include a method for cross catalog searching, the method comprising: receiving a search query and user authentication data at a procurement system, the procurement system having an internal catalog comprising internal catalog information associated with a plurality of products; retrieving the internal catalog information associated with at least one of a plurality of products based on the search query; transmitting the search query to REST APIs of a plurality of external catalogs, wherein the plurality of external catalogs are organized in iXML format; extracting one or more iXML responses from the REST APIs of the plurality of external catalogs, wherein each of the one or more iXML responses comprise external catalog information related to the at least one of the plurality of products, the external catalog information is particularized to the user based on the user authentication data; storing the external catalog information related to the at least one of the plurality of products in an internal search database of the procurement system; and displaying both the retrieved internal catalog information and the external catalog information of the at least one of the plurality of products on a single interface of the procurement system.

Alternatively and/or additionally, Example 2 comprises Example 1, and further comprises performing a subsequent query of the external catalog information stored in the internal search database, wherein the subsequent query includes requesting additional information to be displayed along with the external catalog information of one of the plurality of products.

Alternatively and/or additionally, Example 3 comprises one or more of Examples 1-2, wherein requesting the additional information comprises transmitting the subsequent search query to the REST APIs of the plurality of external catalogs and extracting one or more subsequent iXML responses including the additional information.

Alternatively and/or additionally, Example 4 comprises one or more of Examples 1-3, wherein displaying both the retrieved internal catalog information and the external catalog information on the single interface includes displaying the additional information.

Alternatively and/or additionally, Example 5 comprises one or more of Examples 1-4, wherein displaying the additional information comprises displaying one or more attributes of the one of the plurality of products.

Alternatively and/or additionally, Example 6 comprises one or more of Examples 1-5, and further comprises comparing the internal catalog information with the external catalog information responsive to transcoding the internal catalog information based on UNSPSC standardization of commodities.

Alternatively and/or additionally. Example 7 comprises one or more of Examples 1-6, wherein displaying both the retrieved internal catalog information and the external catalog information on the single interface includes tagging the external catalog information to differentiate from the internal catalog information.

Alternatively and/or additionally. Example 8 comprises one or more of Examples 1-7, and further comprises selecting ones of the plurality of products displayed on the single interface directly from the procurement system.

Alternatively and/or additionally, Example 9 comprises one or more of Examples 1-8, wherein selecting ones of the plurality of products includes adding a characteristic of the selected products.

Alternatively and/or additionally, Example 10 comprises one or more of Examples 1-9, and further comprises implementing a purchase order for selected ones of the plurality of products displayed on the single interface directly from the procurement system.

Example 11 may include a method for cross catalog searching, the method comprising receiving a search query at a procurement system, the procurement system having an internal catalog comprising a first plurality of products from a buyer-side procurement system; retrieving respective ones of the first plurality of products from the internal catalog based on the search query and storing in the internal search database; transmitting the search query to APIs of a plurality of external catalogs, wherein the plurality of external catalogs are organized in iXML format; extracting one or more iXML responses from the APIs of the plurality of external catalogs, wherein each of the one or more iXML responses comprise external catalog data related to respective ones of a second plurality of products; storing the external catalog data related to the respective ones of a second plurality of products in the internal search database; and displaying both the respective ones of the first plurality of products and the second plurality of products on a single interface of the procurement system.

Alternatively and/or additionally, Example 12 comprises Examples 11 and further comprises receiving user authentication data.

Alternatively and/or additionally, Example 13 comprises one or more of Examples 1 1-12, wherein the external catalog data related to respective ones of a second plurality of products is particularized to the user based on the user authentication data.

Alternatively and/or additionally, Example 14 comprises one or more of Examples 11-13, and further comprises comparing the respective ones of the first plurality of products with the second plurality of products responsive to transcoding the first plurality of products based on UNSPSC standardization of commodities.

Example 15 may include a method for receiving a product query from a user; searching an internal catalog of products and a plurality of external catalogs for at least one product related to the product query, wherein searching the plurality of external catalogs comprises interrogating respective APIs of the plurality of external catalogs to access the plurality of external catalogs; extracting external catalog information related to the at least one product across the plurality of external catalogs and storing in an internal search database; extracting internal catalog information related to the at least one product from the internal catalog and storing in the internal search database; and generating a requisition order for the at least one product.

The present disclosure is not to be limited in terms of the particular examples described in this application, which are intended as illustrations of various aspects. Many modifications and examples can be made without departing from its spirit and scope, as will be apparent to those skilled in the art. Functionally equivalent methods; and apparatuses within the scope of the disclosure, in addition to those enumerated herein, will be apparent to those skilled in the art from the above descriptions. Such modifications and examples are intended to fall within the scope of the appended claims. The present disclosure is to be limited only by the terms of the appended claims, along with the full scope of equivalents to which such claims are entitled, it is to be understood that this disclosure is not limited to particular methods, which can, of course, vary. It is also to be understood that the terminology used herein is for the purpose of describing particular examples only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation, no such intent is present. For example, as an aid to understanding, the following appended clams may contain usage of the introductory phrases “at least one” and “one or more” to introduce clam recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 items refers to groups having 1, 2, or 3 items. Similarly, a group having 1-5 items refers to groups having 1, 2, 3, 4, or 5 items, and so forth.

What is claimed is:

1. A method for cross catalog searching, the method comprising:
receiving a search query and user authentication data at a procurement system, the procurement system having an internal catalog comprising internal catalog information associated with a plurality of products;
retrieving the internal catalog information associated with at least one of a plurality of products based on the search query;
transmitting the search query to REST APIs of a plurality of external catalogs, wherein the plurality of external catalogs are organized in iXML format;
extracting one or more iXML responses from the REST APIs of the plurality of external catalogs, wherein each of the one or more iXML responses comprise external catalog information related to the at least one of the plurality of products, the external catalog information is particularized to the user based on the user authentication data;
storing the external catalog information related to the at least one of the plurality of products in an internal search database of the procurement system; and
displaying both the retrieved internal catalog information and the external catalog information of the at least one of the plurality of products on a single interface of the procurement system.

2. The method of claim 1, further comprising performing a subsequent query of the external catalog information stored in the internal search database, wherein the subsequent query includes requesting additional information to be displayed along with the external catalog information of one of the plurality of products.

3. The method of claim 2, wherein requesting the additional information comprises transmitting the subsequent search query to the REST APIs of the plurality of external catalogs and extracting one or more subsequent iXML responses including the additional information.

4. The method of claim 2, wherein displaying both the retrieved internal catalog information and the external catalog information on the single interface includes displaying the additional information.

5. The method of claim 4, wherein displaying the additional information comprises displaying one or more attributes of the one of the plurality of products.

6. The method of claim 1, further comprising comparing the internal catalog information with the external catalog information responsive to transcoding the internal catalog information based on UNSPSC standardization of commodities.

7. The method of claim 1, wherein displaying both the retrieved internal catalog information and the external catalog information on the single interface includes tagging the external catalog information to differentiate from the internal catalog information.

8. The method of claim 1, further comprising selecting ones of the plurality of products displayed on the single interface directly from the procurement system.

9. The method of claim 8, wherein selecting ones of the plurality of products includes adding a characteristic of the selected products.

10. The method of claim 9, further comprises implementing a purchase order for selected ones of the plurality of products displayed on the single interface directly from the procurement system.

11. A method for cross catalog searching, the method comprising:
receiving a search query at a procurement system, the procurement system having an internal catalog comprising a first plurality of products from a buyer-side procurement system;
retrieving respective ones of the first plurality of products from the internal catalog based on the search query and storing in the internal search database;
transmitting the search query to APIs of a plurality of external catalogs, wherein the plurality of external catalogs are organized in iXML format;
extracting one or more iXML responses from the APIs of the plurality of external catalogs, wherein each of the one or more iXML responses comprise external catalog data related to respective ones of a second plurality of products;
storing the external catalog data related to the respective ones of a second plurality of products in the internal search database; and
displaying both the respective ones of the first plurality of products and the second plurality of products on a single interface of the procurement system.

12. The method of claim 11, further comprising receiving user authentication data.

13. The method of claim 12. wherein the external catalog data related to respective ones of a second plurality of products is particularized to the user based on the user authentication data.

14. The method of claim 11, further comprising comparing the respective ones of the first plurality of products with the second plurality of products responsive to transcoding the first plurality of products based on UNSPSC standardization of commodities.

15. A method comprising:
receiving a product query from a user;
searching an internal catalog of products and a plurality of external catalogs for at least one product related to the product query, wherein searching the plurality of external catalogs comprises interrogating respective APIs of the plurality of external catalogs to access the plurality of external catalogs;
extracting external catalog information related to the at least one product across the plurality of external catalogs and storing in an internal search database;
extracting internal catalog information related to the at least one product from the internal catalog and storing in the internal search database; and
generating a requisition order for the at least one product.
